(19) United States
(12) Patent Application Publication
(10) Pub. No.: US 2024/0143025 A1
(43) Pub. Date: May 2, 2024

(54) DISPLAY PANELS

(71) Applicant: Hewlett-Packard Development Company, L.P., Spring, TX (US)

(72) Inventor: Daniel Matthew Ralls, Spring, TX (US)

(21) Appl. No.: 17/977,738

(22) Filed: Oct. 31, 2022

(51) Int. Cl. G02F 1/1347; G02F 1/1333; G02F 1/1334; G06F 1/16; G06F 3/041

(52) U.S. Cl. CPC G02F 1/1347; G02F 1/13338; G02F 1/1334; G06F 1/1616; G06F 3/0416

(57) ABSTRACT

In some examples, an electronic device includes a transparent display panel including a first side facing a first direction and a second side facing a second direction. In some examples, the electronic device includes a first switchable opacity panel disposed in the first direction from the transparent display panel. In some examples, the electronic device includes a second switchable opacity panel disposed in the second direction from the transparent display panel.

### BACKGROUND

Electronic technology has advanced to become virtually ubiquitous in society and has been used for many activities in society. For example, electronic devices are used to perform a variety of tasks, including work activities, communication, research, and entertainment. Different varieties of electronic circuitry may be utilized to provide different varieties of electronic technology.

### BRIEF DESCRIPTION OF THE DRAWINGS

FIG. 1 is a diagram illustrating a side elevation view of an example of an electronic device;

FIG. 2 is a diagram illustrating a side elevation view of an example of a first mode of a portion of the electronic device described in relation to FIG. 1;

FIG. 3 is a diagram illustrating a side elevation view of an example of a second mode of a portion of the electronic device described in relation to FIG. 1;

FIG. 4 is a diagram illustrating a side elevation view of an example of an electronic device;

FIG. 5 is a flow diagram illustrating an example of a method for controlling panel in accordance with some of the techniques described herein;

FIG. 6 is a diagram illustrating an example of a laptop computer that includes a display in accordance with some of the techniques described herein;

FIG. 7 is a diagram illustrating an example of the laptop computer described in relation to FIG. 6; and

FIG. 8 is a block diagram illustrating an example of a computer-readable medium for controlling a display.

### DETAILED DESCRIPTION

An electronic device is a device that includes electronic circuitry. Examples of an electronic device may include a computer (e.g., laptop computer), a smartphone, a tablet computer, a mobile device, display device, television, light wall, etc. A display device is a device to display light and/or an image(s). Examples of a display device may include a monitor, a display screen, a touchscreen, a laptop display, etc.

Some examples of the techniques described herein include a transparent display panel that can be viewed with clarity from either side. A switchable opacity panel (e.g., electrostatic film) may be disposed on either side of the transparent display panel to enable the display to be usable from either side. In some examples, a contact sensor(s) (e.g., touch sensor(s), stylus sensor(s), pen digitizer(s), etc.) may be disposed in the display. For instance, using a pen digitizer on a back side of the display may allow a user to electronically ink on the “lid” of a display when a clamshell device (e.g., laptop computer, notebook computer, etc.) is partially or completely closed.

Some approaches to inking sensing utilize a complex, heavy, and/or expensive hinge mechanism, or utilize a discrete inking device outside of a notebook computer. Some examples of the techniques described herein may enhance functional integration in electronic devices, may reduce electronic device weight, and/or may provide enhanced flexibility for electronic device use (e.g., enhanced flexibility for use with a stylus, touch contact, and/or other input device use). For instance, some of the techniques described herein may provide additional usage scenarios and/or may provide built-in electronic inking capabilities (which may provide enhanced convenience relative to carrying an additional inking device, for example).

Throughout the drawings, similar reference numbers may designate similar or identical elements. When an element is referred to without a reference number, this may refer to the element generally, without limitation to any particular drawing or figure. In some examples, the drawings are not to scale, and the size of some parts may be exaggerated to more clearly illustrate the example shown. Moreover, the drawings provide examples in accordance with the description. However, the description is not limited to the examples provided in the drawings.

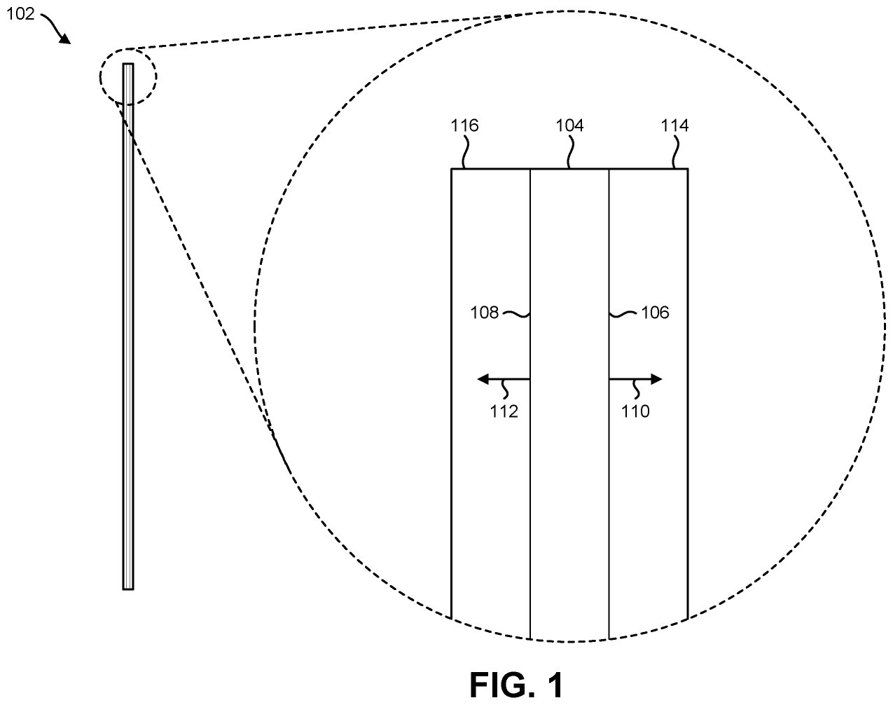

FIG. 1 is a diagram illustrating a side elevation view of an example of an electronic device 102. FIG. 1 illustrates a magnified view of a portion of the electronic device 102 for detail. In some examples, the electronic device 102 may include a transparent display panel 104, a first switchable opacity panel 114, and a second switchable opacity panel 116. In some examples, the electronic device 102 may include an additional component(s) (not shown in FIG. 1). For instance, the electronic device 102 may be (and/or may include components of) a clamshell device (e.g., a clamshell phone, a laptop computer including a body with a keyboard and including the transparent display panel 104 in a hinge-up, etc.), tablet device, smartphone, television, monitor, smart appliance, display wall, tabletop display, window display, vehicle console, etc.

The transparent display panel 104 is a panel of transparent material (e.g., plastic, glass, acrylic resin, epoxy, etc.) including a set of image elements (e.g., pixels). Examples of the transparent display panel 104 may include an organic light emitting diode (OLED) panel, quantum dot light emitting diode (QLED) panel, liquid crystal display (LCD) panel, light emitting diode (LED) panel, etc. In some examples, the image elements (e.g., pixels) may be organized in a grid or array, where each image element may be controllable to emit color and/or light. For instance, an OLED panel may be a semiconductor device including a substrate (e.g., glass, plastic, acrylic resin, epoxy, etc.), anode layer, conductive layer, emissive layer, and cathode layer. When a current is applied to an image element (e.g., pixel), the image element may produce light and/or color. Other panel components may be utilized in some examples. Image elements (e.g., pixels) may be controlled to produce an image(s) (e.g., video, still image(s), user interface element(s), etc.).

The transparent display panel 104 may include a first side 106 facing a first direction 110 and a second side 108 facing a second direction 112. The first direction 110 may be approximately perpendicular to a surface of the first side 106. The second direction 112 may be approximately perpendicular to a surface of the second side 108. In some examples, the first side 106 and the second side 108 may be opposite sides of the transparent display panel 104. For instance, the first direction 110 and the second direction 112 may be oriented in approximately opposite directions.

A switchable opacity panel is a panel that is controllable to be switched between a transparent state and an opaque state. Examples of a switchable opacity panel may include a polymer dispersed liquid crystal (PDLC) panel, LCD panel, switchable electrostatic film, etc. For instance, a PDLC panel may include a liquid crystal layer disposed between conductive films or coatings (e.g., indium tin oxide coatings). In some examples, a PDLC panel may include another layer(s) (e.g., glass, plastic, polyethylene terephthalate (PET), etc.). The liquid crystal layer may include liquid crystals disposed in polymer. When an electric field is applied to the liquid crystal layer via the conductive films, the liquid crystal molecules may align to cause the panel to enter a transparent state. When the electric field is switched off, the liquid crystal molecules may misalign, causing the panel to enter an opaque state. Some switchable opacity panels may operate differently in some examples (e.g., some LCD panels may utilize a twisted nematic effect to place the panel in an opaque state when an electric field is applied). In some examples, a switchable opacity panel may appear light (e.g., white, frosted, etc.) when in an opaque state. In some examples, an opaque state may allow for the passage of some light (e.g., diffuse light, less than a threshold percentage of light, such as 10%, 5%, 1%, 0.3%, etc.). In some examples, a switchable opacity panel may appear dark (e.g., black, gray, etc.) when in an opaque state.

The electronic device 102 may include a first switchable opacity panel 114 disposed in the first direction 110 from the transparent display panel 104. In some examples, the first switchable opacity panel 114 may be disposed next to and/or may be attached to (e.g., adhered to) the first side 106 of the transparent display panel 104. In some examples, another layer(s) and/or film(s) may be disposed between the transparent display panel 104 and the first switchable opacity panel 114.

The electronic device 102 may include a second switchable opacity panel 116 disposed in the second direction 112 from the transparent display panel 104. In some examples, the second switchable opacity panel 116 may be disposed next to and/or may be attached to (e.g., adhered to) the second side 108 of the transparent display panel 104. In some examples, another layer(s) and/or film(s) may be disposed between the transparent display panel 104 and the second switchable opacity panel 116.

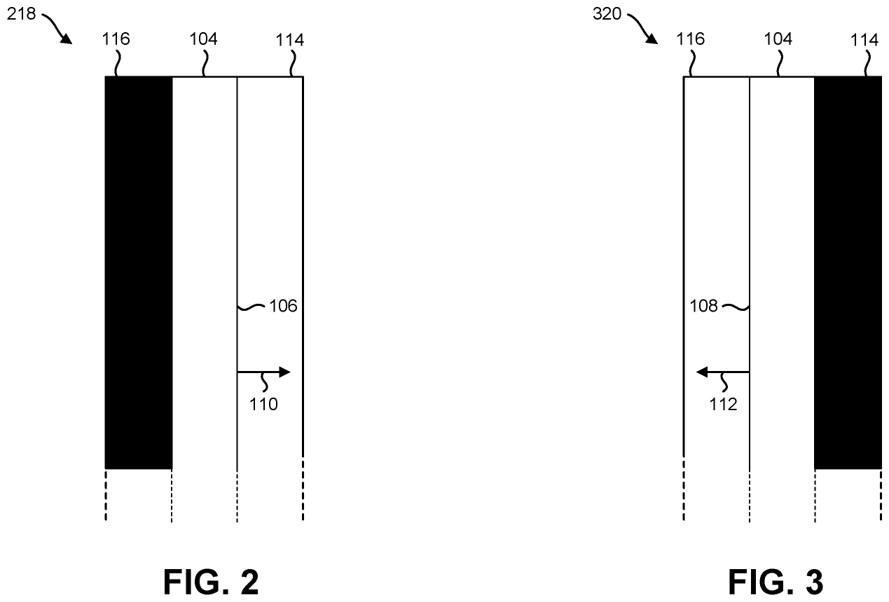

In some examples, the electronic device 102 may operate according to modes. For instance, the first switchable opacity panel 114 may be in a transparent state and the second switchable opacity panel 116 may be in an opaque state in a first mode to allow the transparent display panel 104 to be viewable on the first side 106 (e.g., in the first direction 110). For example, an image(s) produced by the transparent display panel 104 may be emitted (e.g., displayed) in the first direction 110 and blocked in the second direction 112 while operating in the first mode. An example of the first mode is described in relation to FIG. 2.

In some examples, the first switchable opacity panel 114 may be in an opaque state and the second switchable opacity panel 116 may be in a transparent state in a second mode to allow the transparent display panel 104 to be viewable on the second side 108 (e.g., in the second direction 112). For example, an image(s) produced by the transparent display panel 104 may be emitted (e.g., displayed) in the second direction 112 and blocked in the first direction 110 while operating in the second mode. An example of the second mode is described in relation to FIG. 3.

In some examples, the first switchable opacity panel 114 may be in a transparent state and the second switchable opacity panel 116 may be in a transparent state in a third mode to allow the transparent display panel 104 to be viewable on the first side 106 (e.g., in the first direction 110) and on the second side 108 (e.g., in the second direction 112). For example, an image(s) produced by the transparent display panel 104 may be emitted (e.g., displayed) in the first direction 110 and in the second direction 112 while operating in the third mode.

In some examples, the first switchable opacity panel 114 may be in an opaque state and the second switchable opacity panel 116 may be in an opaque state in a fourth mode (e.g., low power mode, privacy mode, etc.) to block viewing of the transparent display panel 104 on the first side 106 (e.g., in the first direction 110) and on the second side 108 (e.g., in the second direction 112). For example, an image(s) produced by the transparent display panel 104 may be blocked (e.g., covered) in the first direction 110 and in the second direction 112 while operating in the fourth mode.

In some examples, the electronic device 102 may include a contact sensor. For instance, circuitry (e.g., capacitors) to detect changes in an electrostatic field may be included in the electronic device 102. Examples of a contact sensor may include a touch sensor, capacitive matrix (e.g., contact-sensitive capacitive grid), resistive matrix (e.g., contact-sensitive resistive grid), pressure sensor, or a combination thereof), electrostatic field sensor (e.g., electrode(s)), etc. In some examples, a contact sensor (e.g., capacitive grid, contact sensor panel, etc.) may correspond to (e.g., may be layered with) the transparent display panel 104, the first switchable opacity panel 114 and/or the second switchable opacity panel 116. In some examples, multiple contact sensors may be utilized. For instance, the electronic device 102 may include a first contact sensor panel disposed next to the first switchable opacity panel 114 and a second contact sensor panel disposed next to the second switchable opacity panel 116. In some examples, the first contact sensor panel may be utilized to detect a contact(s) in the first direction 110 and/or the second contact sensor panel may be utilized to detect a contact(s) in the second direction 112. In some examples, one contact sensor (e.g., a single contact sensor panel) may be utilized to detect a contact(s) in either direction or both directions (e.g., in the first direction 110 and/or in the second direction 112). In some examples, a contact sensor(s) (e.g., contact sensor panel(s)) may be transparent.

In some examples, the contact sensor(s) may detect a contact(s). For instance, the contact sensor(s) may detect positional information of a stylus(es) and/or finger(s) in contact with the electronic device 102. Positional information is data indicating a spatial position. For instance, the positional information may indicate a spatial position(s) of a contact on the electronic device 102 (e.g., display surface). In some examples, positional information may include contact sensor coordinates (e.g., x and y coordinates of a detected contact or touch). For instance, the contact sensor may detect coordinates of a contact point corresponding to a user (e.g., a user's finger). In some examples, a contact point and/or contact pattern detected by the contact sensor(s) may be utilized as input to the electronic device 102.

In some examples, the contact sensor(s) may detect a contact associated with a side (e.g., the first side 106 or the second side 108) in accordance with a state. For instance, a contact sensor may detect a contact associated with the second side 108 when the first switchable opacity panel 114 is in an opaque state and the second switchable opacity panel 116 is in a transparent state. In some examples, a contact sensor may detect a contact associated with the first side 106 when the first switchable opacity panel 114 is in a transparent state and the second switchable opacity panel 116 is in an opaque state.

In some examples, the electronic device 102 is a clamshell device including a display and a body. For instance, the electronic device 102 may be a laptop computer with a body including an input device(s) (e.g., keyboard, trackpad, and/or port(s), etc.). The transparent display panel 104, the first switchable opacity panel 114, and the second switchable opacity panel 116 may be included in the display (e.g., hinge-up display). The first side 106 may be disposed to an interior side of the display. For instance, when the clamshell device is closed, the first side 106 may face the body (e.g., the first direction 110 may be oriented toward a deck of the body) and/or the second side 108 may be disposed toward an exterior side of the display of the clamshell device (e.g., may face outwardly). In some examples, the display may be coupled to the body by a hinge with a rotation axis (e.g., single rotation axis). In some examples, the hinge may provide rotation in a limited range (e.g., <360°, <180°, ≤150°, ≤140°, ≤135°, etc.) between the body and the display.

In some examples, a mode may be selected and/or activated based on an input(s). For instance, a mode may be selected and/or activated in response to a hinge state, detected contact(s), and/or other input(s) (e.g., keyboard input, touchpad input, etc.). In some examples, if a hinge state indicates an open state (for a clamshell device, for instance), the first mode may be selected and/or activated. For instance, the first switchable opacity panel 114 may be set to a transparent state and the second switchable opacity panel 116 may be set to an opaque state. In some examples, if a contact (e.g., stylus and/or finger contact) is detected in the first direction 110, the first mode may be selected and/or activated. In some examples, if a keyboard or touchpad input is detected (for a clamshell device, for instance), the first mode may be selected and/or activated. In some examples, a combination of conditions (e.g., hinge state, detected contact(s), and/or other input(s)) may be utilized to control a mode. In some examples, the first mode may be utilized for scenarios in which a user is using a clamshell device with the hinge open and/or the user is viewing the transparent display panel 104 on the first side 106.

In some examples, if a hinge state indicates a closed state (for a clamshell device, for instance), the second mode may be selected and/or activated. For instance, the first switchable opacity panel 114 may be set to an opaque state and the second switchable opacity panel 116 may be set to a transparent state. In some examples, if a contact (e.g., stylus and/or finger contact) is detected in the second direction 112, the second mode may be selected and/or activated. In some examples, the second mode may be utilized for scenarios in which a user is using a clamshell device with the hinge closed and/or the user is viewing the transparent display panel 104 on the second side 108. For instance, the second mode may be utilized as a tablet mode and/or an electronic inking mode (e.g., to capture stylus input on the “lid”). In some examples, the second mode may be utilized when the hinge is in the open state. For instance, a clamshell device may be situated facing away from a user with the hinge-up opened to provide an inclined surface for input.

In some examples, a third mode may be selected and/or activated in response to a hinge state, detected contact(s), and/or other input(s) (e.g., keyboard input, touchpad input, etc.). For instance, if a hinge state indicates an open state (for a clamshell device, for instance), and an input (e.g., keyboard input, contact(s), and/or touchpad input, etc.) is detected indicating the third mode, the third mode may be selected and/or activated. For instance, the first switchable opacity panel 114 may be set to a transparent state and the second switchable opacity panel 116 may be set to a transparent state. In some examples, the third mode may be utilized for scenarios in which the display is to be shared by users situated on different sides of the electronic device 102. For instance, the third mode may be utilized to share content to a back of a device, to present data (e.g., a slideshow) to a user behind a device, and/or to allow multiple users to utilize the electronic device 102 concurrently. In some examples, an image orientation may be reversed (e.g., flipped side-to-side, flipped horizontally, etc.) for the second mode and/or for the third mode.

In some examples, a contact sensor(s) may be controlled based on an input(s) and/or mode(s) (e.g., may be selected and/or activated in response to a hinge state, detected contact(s), and/or other input(s)). In some examples, a contact sensor in the second direction 112 may be inactive (e.g., deactivated) in the first mode and/or a contact sensor in the first direction 110 may be active (e.g., activated) in the first mode. In some examples, a contact sensor in the second direction 112 may be active (e.g., activated) in the second mode and/or a contact sensor in the first direction 110 may be inactive (e.g., deactivated) in the second mode. For instance, a contact sensor in the first direction 110 may be deactivated when a hinge state indicates that a clamshell device is closed. In some examples, a contact sensor in the second direction 112 may be active (e.g., activated) in the third mode and/or a contact sensor in the first direction 110 may be active (e.g., activated) in the third mode.

In some examples, the electronic device 102 may include (and/or may be coupled to) logic circuitry (e.g., a processor(s), display controller(s), etc.) to receive an input(s) detected by a sensor(s) (e.g., hinge sensor(s), contact senor(s), keyboard(s), touch pad(s), etc.). The logic circuitry may control the states of the first switchable opacity panel 114, the second switchable opacity panel 116, and/or the contact sensor(s). In some examples, the logic circuitry may determine and/or execute a mode as described herein.

FIG. 2 is a diagram illustrating a side elevation view of an example of a first mode 218 of a portion of the electronic device 102 described in relation to FIG. 1. In this example, the second switchable opacity panel 116 is placed in an opaque state and the first switchable opacity panel 114 is placed in a transparent state. The first side 106 of the transparent display panel 104 is viewable in the first direction 110.

FIG. 3 is a diagram illustrating a side elevation view of an example of a second mode 320 of a portion of the electronic device 102 described in relation to FIG. 1. In this example, the second switchable opacity panel 116 is placed in a transparent state and the first switchable opacity panel 114 is placed in an opaque state. The second side 108 of the transparent display panel 104 is viewable in the second direction 112.

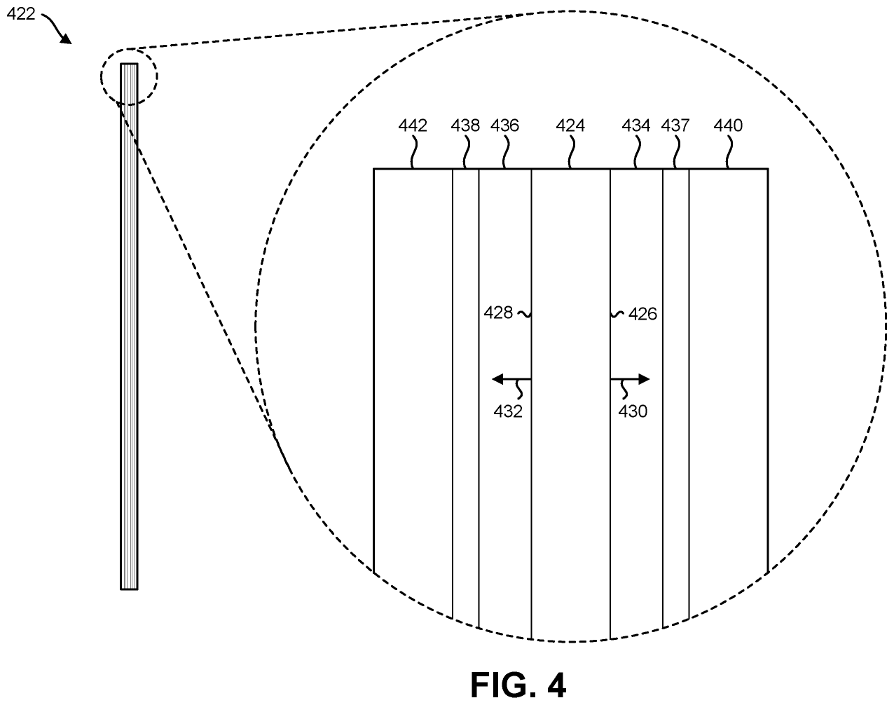

FIG. 4 is a diagram illustrating a side elevation view of an example of an electronic device 422. FIG. 4 illustrates a magnified view of a portion of the electronic device 422 for detail. The electronic device 422 may be an example of the electronic device 102 described in relation to FIG. 1. In some examples, the electronic device 422 may include a transparent display panel 424, a first switchable opacity panel 434, a second switchable opacity panel 436, a first contact sensor 437 (e.g., first contact sensor panel), a second contact sensor 438 (e.g., second contact sensor panel), a first glass panel 440, and a second glass panel 442. In some examples, the components described in relation to FIG. 4 may be examples of corresponding components described in relation to FIG. 1. In some examples, some of the components (e.g., the transparent display panel 424, first switchable opacity panel 434, second switchable opacity panel 436, first contact sensor 437 (e.g., first contact sensor panel), second contact sensor 438 (e.g., second contact sensor panel), first glass panel 440, and/or second glass panel 442) may have a thickness (e.g., total or cumulative thickness) of approximately 4-8 millimeters (mm) (e.g., 5 mm).

In the example of FIG. 4, the transparent display panel 424 includes a first side 426 facing a first direction 430 and a second side 428 facing a second direction 432. The first switchable opacity panel 434 is disposed next to and/or may be attached to (e.g., adhered to) the first side 426 of the transparent display panel 424. The second switchable opacity panel 436 is disposed next to and/or may be attached to (e.g., adhered to) the second side 428 of the transparent display panel 424.

In the example of FIG. 4, the first contact sensor 437 is disposed next to and/or may be attached to (e.g., adhered to) the first switchable opacity panel 434. The second contact sensor 438 is disposed next to and/or may be attached to (e.g., adhered to) the second switchable opacity panel 436. In the example of FIG. 4, the first glass panel 440 is disposed next to and/or may be attached to (e.g., adhered to) the first contact sensor 437. The second glass panel 442 is disposed next to and/or may be attached to (e.g., adhered to) the second contact sensor 438. In some examples, another layer(s) and/or film(s) may be disposed in (and/or on) the electronic device 422. In some examples, a single contact sensor (e.g., contact sensor panel) may be utilized instead of two contact sensors. The single contact sensor may sense contact from one side or both sides of the electronic device 422.

In some examples, the first switchable opacity panel 434, the second switchable opacity panel 436, the first contact sensor 437, and/or the second contact sensor 438 may be controlled as described in relation to FIG. 1 (e.g., may be selected, activated, and/or deactivated based on an input(s) and/or mode(s)).

The first glass panel 440 and the second glass panel 442 may protect the inner panels of the electronic device 422. In some examples, the first glass panel 440 and the second glass panel 442 may be fabricated with tempered glass. In some examples, another protective panel (e.g., plastic, epoxy, etc.) may be utilized instead of glass or in addition to glass. In some examples, a glass, plastic, and/or epoxy panel may be transparent.

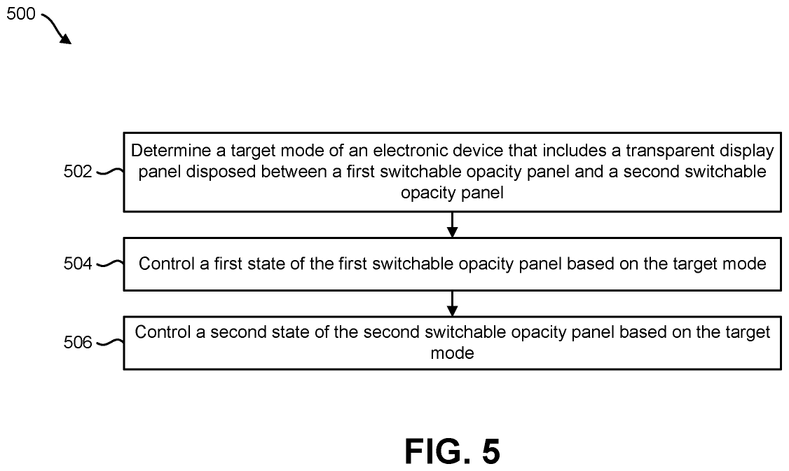

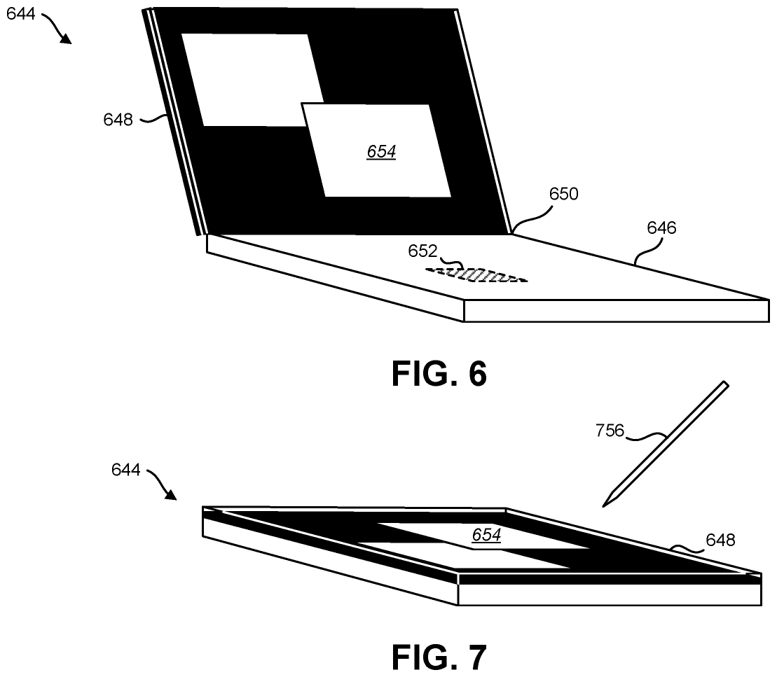

FIG. 5 is a flow diagram illustrating an example of a method 500 for controlling panel in accordance with some of the techniques described herein. In some examples, the method 500 or a method 500 element(s) may be performed by an electronic device or apparatus (e.g., electronic device 102, electronic device 422, laptop computer, smartphone, tablet device, etc.). For example, the method 500 may be performed by the electronic device 102 described in FIG. 1, the electronic device 422 described in relation to FIG. 4, and/or the laptop computer 644 described in relation to FIG. 6.

The method 500 may include determining 502 a target mode of an electronic device that includes a transparent display panel disposed between a first switchable opacity panel and a second switchable opacity panel. In some examples, determining 502 a target mode may be performed as described in relation to FIG. 1. For instance, the electronic device may obtain an input (e.g., hinge sensor input, contact input, touch pattern, keyboard input, etc.) from a sensor(s) (e.g., hinge sensor(s), contact sensor(s), keyboard, touch pad, etc.). The electronic device may determine a target mode based on the input. In some examples, determining 502 the target mode may include detecting an input indicating the target mode. For instance, the input may indicate a selection (e.g., tap, click, return, etc.) on a user interface control indicating the target mode (e.g., first mode, second mode, third mode, or fourth mode.). In some examples, the electronic device may utilize a function, mapping, and/or lookup table to determine the target mode.

In some examples, if a hinge state is open and a keyboard input, touch pad input, and/or contact from a front contact sensor is detected, the electronic device may determine that the target mode is the first mode. In some examples, if a hinge state is open after a closed hinge state, the electronic device may determine that the target mode is the first mode. In some examples, if a hinge state is closed and a contact is detected by a contact sensor (e.g., a back contact sensor), the electronic device may determine that the target mode is the second mode. In some examples, if a hinge state is open and a contact from a back contact sensor is detected, the electronic device may determine that the target mode is the second mode. In some examples, if a hinge state is open and contacts from a front contact sensor and from a back contact sensor are detected, the electronic device may determine that the target mode is the third mode. In some examples, if no input is detected for a threshold period of time (e.g., 2 minutes), the electronic device may determine that the target mode is the fourth mode. Other approaches to determine the target mode may be utilized in some examples.

The method 500 may include controlling 504 a first state of the first switchable opacity panel based on the target mode. In some examples, controlling 504 a first state may be performed as described in relation to FIG. 1, FIG. 2, FIG. 3, and/or FIG. 4. For instance, the electronic device (e.g., logic circuitry, mode controller, etc.) may control the first state of the first switchable opacity panel by activating or deactivating a current and/or voltage to activate or deactivate the first switchable opacity panel. For instance, if the target mode is the first mode or third mode, the electronic device may set the first state to a transparent state. In some examples, if the target mode is the second or fourth mode, the electronic device may set the first state to an opaque state.

The method 500 may include controlling 506 a second state of the second switchable opacity panel based on the target mode. In some examples, controlling 506 a second state may be performed as described in relation to FIG. 1, FIG. 2, FIG. 3, and/or FIG. 4. For instance, the electronic device (e.g., logic circuitry, mode controller, etc.) may control the second state of the second switchable opacity panel by activating or deactivating a current and/or voltage to activate or deactivate the second switchable opacity panel. For instance, if the target mode is the second mode or third mode, the electronic device may set the second state to a transparent state. For instance, in response to determining that a display of the electronic device is closed, controlling 504 the first state may include setting the first switchable opacity panel to an opaque state and controlling 506 the second state may include setting the second switchable opacity panel to a transparent state. In some examples, if the target mode is the first mode or fourth mode, the electronic device may set the second state to an opaque state.

FIG. 6 is a diagram illustrating an example of a laptop computer 644 that includes a display in accordance with some of the techniques described herein. In some examples, the laptop computer 644 may be an example of the electronic device 102 described in FIG. 1 and/or the electronic device 422 described in FIG. 4. In this example, the laptop computer 644 includes a body 646 and a display 648. In some examples, the display 648 may be rotatably coupled to the body 646 with a hinge 650, which may allow the display 648 to rotate into contact with the body 646 when closing the laptop computer 644.

The body 646 may house a component(s). For example, the body 646 may house a logic circuitry 652. The logic circuitry 652 may be a processor, controller (e.g., mode controller), display controller, central processing unit (CPU), and/or application processor, etc. Examples of other components that may be housed in the body 646 may include memory or storage (e.g., random access memory (RAM), solid state drive (SSD), etc.), a keyboard, motherboard, port(s), etc.

The display 648 may include a component(s). For example, the display 648 may include a transparent display panel disposed between a first switchable opacity panel and a second switchable opacity panel. For instance, the display 648 may include the components described in relation to FIG. 1, the components described in relation to FIG. 4, and/or another component(s). In some examples, the display 648 may be coupled to the logic circuitry 652 via an interface and/or electronic link. The logic circuitry 652 may receive data (e.g., contact input(s), electronic inking input(s), etc.) from the display 648 and/or may receive data (e.g., keyboard input(s), touch pad input(s), port input(s), etc.) from the body 646. The logic circuitry 652 (e.g., mode controller) may control a first state of a first switchable opacity panel included in the display 648 and/or may control a second state of a second switchable opacity panel included in the display 648. For instance, the logic circuitry 652 may process the data to determine a target mode and may control the first state and the second state to set the target mode.

In some examples, the display 648 may include a first contact sensor panel disposed next to the first switchable opacity panel and/or may include a second contact sensor panel disposed next to the second switchable opacity panel. In some examples, the logic circuitry 652 (e.g., mode controller) may control the first state of the first switchable opacity panel and the second state of the second switchable opacity panel based on the sensed contact.

In the example of FIG. 6, the laptop computer 644 is illustrated in the first mode, where the second (e.g., back) switchable opacity panel is in an opaque state and the second (e.g., front) switchable opacity panel is in a transparent state to show content 654 displayed on the transparent display panel.

FIG. 7 is a diagram illustrating an example of the laptop computer 644 described in relation to FIG. 6. In the example of FIG. 7, the laptop computer 644 is illustrated in the second mode, where the second (e.g., back) switchable opacity panel is in a transparent state and the second (e.g., front) switchable opacity panel is in an opaque state to show content 654 displayed on the transparent display panel.

In some examples, a stylus 756 (e.g., passive stylus, active stylus, electronic pen, etc.) may be utilized with the laptop computer 644 in the second mode. For instance, a second contact sensor disposed in the display 648 may be utilized to detect contact from the stylus 756 (for interaction with the laptop computer 644, for instance). A stylus is an object and/or device for writing or marking (e.g., an electronic writing utensil). In some examples, a stylus may be utilized on a surface to indicate writing or marking. In some examples, movement of a stylus may be sensed (e.g., tracked) by the stylus, an electronic device, sensor(s), or a combination thereof to capture writing or marking. For instance, a contact sensor(s), camera(s), motion sensor(s) (e.g., accelerometer(s)), and/or other tracking device may be utilized to track the movement of a stylus.

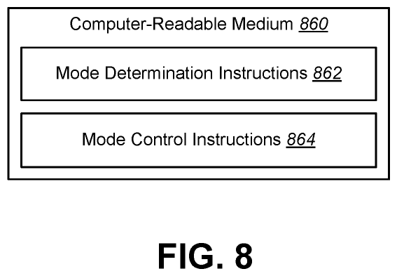

FIG. 8 is a block diagram illustrating an example of a computer-readable medium 860 for controlling a display. The computer-readable medium 860 is a non-transitory, tangible computer-readable medium. In some examples, the computer-readable medium 860 may be, for example, Random Access Memory (RAM), Electrically Erasable Programmable Read-Only Memory (EEPROM), a storage device, an optical disc, the like, or a combination thereof. In some examples, the computer-readable medium 860 may be volatile and/or non-volatile memory, such as Dynamic Random Access Memory (DRAM), EEPROM, magnetoresistive random-access memory (MRAM), and/or phase change RAM (PCRAM). In some examples, the computer-readable medium 860 may be included in a device(s) described herein (e.g., electronic device 102, electronic device 422, laptop computer 644, etc.).

The computer-readable medium 860 may include data (e.g., information, executable instructions, or a combination thereof). In some examples, the computer-readable medium 860 may include mode determination instructions 862 and/or mode control instructions 864.

The mode determination instructions 862 may include instructions when executed cause logic circuitry (e.g., a processor) of an electronic device to determine a target mode. In some examples, determining a target mode may be performed as described in one, some, or all of FIGS. 1-7.

The mode control instructions 864 may include instructions when executed cause the logic circuitry to control a mode of the display. In some examples, controlling a mode of the display may be performed as described in one, some, or all of FIGS. 1-7.

As used herein, the term “and/or” may mean an item or items. For example, the phrase “A, B, and/or C” may mean any of: A (without B and C), B (without A and C), C (without A and B), A and B (but not C), B and C (but not A), A and C (but not B), or all of A, B, and C.

While various examples are described herein, the described techniques are not limited to the examples. Variations of the examples are within the scope of the disclosure. For example, operation(s), aspect(s), or element(s) of the examples described herein may be omitted or combined.

What is claimed is:

1. An electronic device, comprising:
a transparent display panel comprising a first side facing a first direction and a second side facing a second direction;
a first switchable opacity panel disposed in the first direction from the transparent display panel; and
a second switchable opacity panel disposed in the second direction from the transparent display panel.

2. The electronic device of claim 1, wherein the first switchable opacity panel is to be in a transparent state and the second switchable opacity panel is to be in an opaque state in a first mode to allow the transparent display panel to be viewable on the first side.

3. The electronic device of claim 1, wherein the first switchable opacity panel is to be in an opaque state and the second switchable opacity panel is to be in a transparent state in a second mode to allow the transparent display panel to be viewable on the second side.

4. The electronic device of claim 1, wherein the first switchable opacity panel is to be in a transparent state and the second switchable opacity panel is to be in a transparent state in a third mode to allow the transparent display panel to be viewable on the first side and on the second side.

5. The electronic device of claim 1, wherein:
the electronic device is a clamshell device comprising a display and a body;
the transparent display panel, the first switchable opacity panel, and the second switchable opacity panel are included in the display; and
the first side is disposed to an interior side of the display.

6. The electronic device of claim 5, wherein the second side is disposed to an exterior side of the display of the clamshell device.

7. The electronic device of claim 5, wherein the display is coupled to the body by a hinge with a rotation axis.

8. The electronic device of claim 1, further comprising a contact sensor.

9. The electronic device of claim 8, wherein the contact sensor is to detect a contact associated with the second side when the first switchable opacity panel is in an opaque state and the second switchable opacity panel is in a transparent state.

10. A method, comprising:
determining a target mode of an electronic device that includes a transparent display panel disposed between a first switchable opacity panel and a second switchable opacity panel;
controlling a first state of the first switchable opacity panel based on the target mode; and
controlling a second state of the second switchable opacity panel based on the target mode.

11. The method of claim 10, wherein determining the target mode comprises detecting an input indicating the target mode.

12. The method of claim 10, wherein in response to determining that a display of the electronic device is closed:
controlling the first state comprises setting the first switchable opacity panel to an opaque state; and
controlling the second state comprises setting the second switchable opacity panel to a transparent state.

13. An electronic device, comprising:
a display, comprising a transparent display panel disposed between a first switchable opacity panel and a second switchable opacity panel; and
a mode controller to control a first state of the first switchable opacity panel and to control a second state of the second switchable opacity panel.

14. The electronic device of claim 13, wherein the display further comprises:
a first contact sensor panel disposed next to the first switchable opacity panel; and
a second contact sensor panel disposed next to the second switchable opacity panel.

15. The electronic device of claim 14, wherein the mode controller is to control the first state of the first switchable opacity panel and the second state of the second switchable opacity panel based on a sensed contact.
